(19) United States
(12) Patent Application Publication
(10) Pub. No.: US 2026/0037243 A1
(43) Pub. Date: Feb. 5, 2026

(54) APPLICATION CONTAINERIZATION AND DEPLOYMENT SYSTEM LEVERAGING LARGE LANGUAGE MODEL (LLM) CAPABILITIES

(71) Applicant: SAP SE, Walldorf (DE)

(72) Inventors: Manoj Prabhakar KRISHNAMOORTHY, Bengaluru (IN); Sampath Shanmugam, Bengaluru (IN)

(21) Appl. No.: 18/788,928

(22) Filed: Jul. 30, 2024

(51) Int. Cl. G06F 8/60; G06F 9/455

(52) U.S. Cl. CPC G06F 8/60; G06F 9/45558

(57) ABSTRACT

System, method, and various embodiments for an application containerization and deployment system are described herein. An embodiment operates by receiving a command to configure source code of an application for deployment on a deployment platform. A containerization prompt for a large language model (LLM) instructing the LLM to generate a containerization file is generated. The containerization file from the LLM. The containerization file is provided to a containerization validator configured to validate the containerization file. A manifest prompt is generated for the LLM instructing the LLM to generate a manifest for the deployment platform. The manifest is received from the LLM for the deployment platform. The manifest is provided to the deployment platform for deployment.

### BACKGROUND

The deployment of a software application involves both the development of the underlying software code and the actual deployment and management of the application while it is being accessed by users. Completing this life cycle often requires first set of experts who are familiar with software development, and a second set of experts in software deployment. And if there are issues with the deployment, it is difficult to pinpoint where the error occurred. Developing and deploying software is an inefficient, costly, and both time and resource consuming process.

### BRIEF DESCRIPTION OF THE DRAWINGS

The accompanying drawings are incorporated herein and form a part of the specification.

FIG. 1 is a block diagram illustrating example functionality for an application containerization and deployment system (ACS), according to some embodiments.

FIG. 2 is a flowchart illustrating example operations for providing an application containerization and deployment system (ACS), according to some embodiments.

FIG. 3 is a swim lane diagram illustrating example operations for providing an application containerization and deployment system (ACS), according to some embodiments.

FIG. 4 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing an application containerization and deployment system.

The deployment of a software application involves both the development of the underlying software code and the actual deployment and management of the application while it is being accessed by users. Completing this life cycle often requires first set of experts who are familiar with software development, and a second set of experts in software deployment. And if there are issues with the deployment, it is difficult to pinpoint where the error occurred. Developing and deploying software is an inefficient, costly, and both time and resource consuming process.

To deploy an application, the application may need to first be containerized. Containerization may include a method for packaging an application with all its dependencies (e.g., libraries, frameworks, classes, etc.) into a standalone unit called a container. Containerization may include creating a containerization file 122 (e.g., docker file) describing the container image, and generating a manifest 106 (e.g., deployment manifest) that describes the container which includes the container image (e.g., containerization file 122). Generating these and other files may be required prior to deploying source code 104 via a deployment platform 108. However, the generation of these files and components necessary for deployment is often performed in a manual and resource consuming manner that delays deployment and is open to human error.

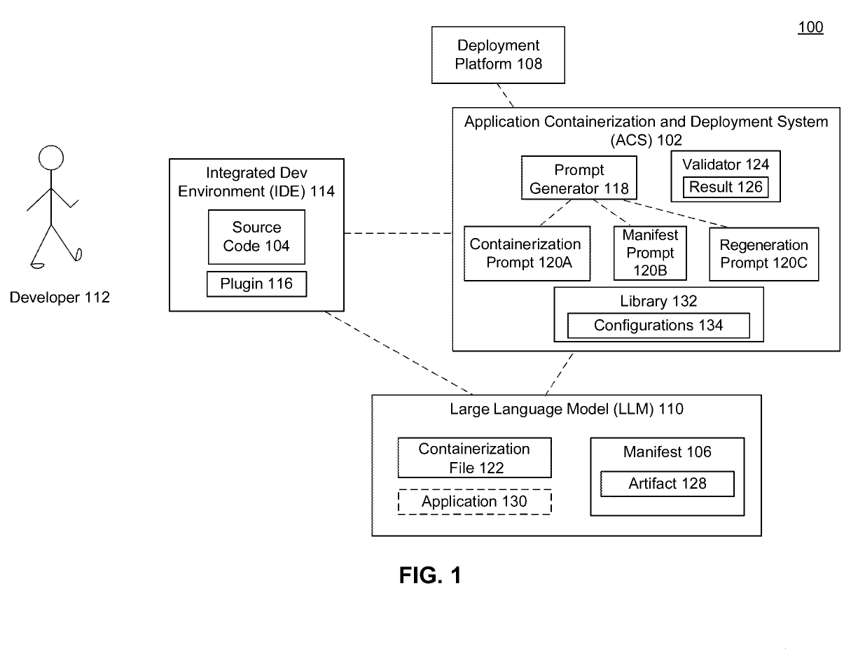

FIG. 1 is a block diagram 100 illustrating example functionality for an application containerization and deployment system (ACS) 102, according to some embodiments. ACS 102 may containerize source code 104 for deployment via a deployment platform 108. ACS 102 reduces development life cycles and the time and computing resources required to containerize and deploy source code 104. Once deployed, the program corresponding to the source code 104 may be accessed and used by various users.

Conventionally, containerizing source code 104 and converting into a deployable file required technological understanding and manual engagement by users. It was a slow and resource consuming process, that delayed the release of production grade software.

ACS 102 leverages the capabilities of a large language model (LLM) 110 to not only produce a containerization file 122 and deployable manifest 106 without user involvement, but also to further train and improve the functionality of the LLM 110, so that further development or deployment functionality may be performed with increasing computational speed and efficiency in performing subsequent containerization tasks.

In some embodiments, a developer 112 may write or arrange source code 104 in an integrated development environment (IDE) 114. IDE 114 may include any program or platform that allows developer 112 to construct, organize, or write (and compile) source code 104. Developer 112 may include one or more human users. In some embodiments, developer 112 may include another computing system (e.g., such as an artificial intelligence system) that has developed the source code 104, and/or source code 104 may be the product of some combination of human and AI system development.

In some embodiments, IDE 114 may include a plugin 116 installed in IDE 114. Plugin 116 may include a software component that adds a specific feature to the IDE 114, such as a connection to ACS 102. Plugin 116 may provide ACS 102 with access the source code 104, without requiring developer 112 to specifically send various files of source code 104 to ACS 102. In some embodiments, the access may be limited to read only access. In some embodiments, developer 112 may request, via the plugin 116, to deploy the source code 104 via deployment platform 108.

Deployment platform 108 may include any computing system with deployment, scaling, and/or management of a software program or application. One example of a deployment platform 108 that may be used is KUBERNETES. KUBERNETES may automate operational tasks of container management and include commands for deploying, scaling, running, load balancing, and monitoring software programs or applications. In other embodiments, other deployment platforms 108 may be used. In addition to KUBERNETES, other deployment platforms which may be used include, but are not limited to, CLOUD FOUNDRY, OPENSHIFT, and MESOS.

Upon receiving a command to deploy source code, plugin 116 may communicate the command to ACS 102. A prompt generator 118 may generate a containerization prompt 120A. Prompt generator 118 may be configured to generate one or more prompts 120A-C for LLM 110, referred to herein generally as prompt 120 or prompts 120.

Prompt 120 may include one or more lines of text organized across one or more documents that is particularly formatted to by understandable by an LLM 110, that indicates what output is to be generated by the LLM 110. LLM 110 may include an artificial intelligence, machine learning, or deep learning model that is configured to execute data processing commands from plain-text (e.g., not requiring computer language or coded input). LLM 110 may include any computing system that is configured to perform processing tasks based on text-based or plain language inputs. LLM 110 may be configured to create original content from one or more documents in accordance with prompt 120. In some embodiments, LLM 110 may include a generative pre-trained transformer (GPT).

In some embodiments, different LLMs 110 may require different prompts 120, or the format of the prompt 120 may impact the quality or type of results or output that is generated by the LLM 110. In some embodiments, prompt generator 118 may generate and format prompt 120 in accordance with whichever LLM(s) 110 is being used to perform the processing described herein, while using the same input command. In some embodiments, prompt generator 118 may generate prompt 120 to include different information or parameters that may be helpful in instructing LLM 110 what to create or generate. In some embodiments, the prompt 120 may include a parameter specify what type of document, file, or output the LLM 110 is to generate.

The containerization prompt 120A may include instructions for LLM 110 to generate a containerization file 122. Containerization file 122 may include a text document that includes instructions for building a containerization image. Containerization file 122 may include a blueprint for creating a customized container environment for packaging source code 104 and its dependencies, so the software application may run consistently across different computing environments or platforms. In some embodiments, containerization file 122 may be used to generate a cross-platform application that is executable on a variable of operating systems without further configuration. In some embodiments, LLM 110 may be configured to generate a containerization file 122 (or multiple containerization files) from source code 104 based on containerization prompt 120A.

LLM 110 may generate and return the containerization file 122 to ACS 102. In some embodiments, LLM 110 may be communicatively coupled to ACS 102 or may communicate with ACS 102 through plugin 116. If LLM 110 is communicatively coupled directly to plugin 116, plugin 116 may act an orchestrator between LLM 110 and ACS 102, and LLM 110 may have direct access to source code 104 via plugin 116. Upon receiving containerization file 122, ACS 102 may validate the containerization file 122 with a validator 124.

Validator 124 may include a program or application that is configured to verify that output generated by LLM 110 was correctly generated. For simplicity, only a single validator 124 is illustrated, however, in some embodiments, multiple validators 124 may exist and be utilized by ACS 102, each one may be configured to validate, examine, or verify different requested output from LLM 110 (e.g. in response to different prompts 120). In some embodiments, ACS 102 may have a unique validator 124 for each prompt 120A-C generated by prompt generator 118.

As described herein, two exemplary validators 124 will be referred to: containerization validator 124 which may be used to validate the output (containerization file 122) from containerization prompt 120A, and manifest validator 124 which may be used to validate the output of a manifest 106 (including parts thereof) in response to manifest prompt 120B. In other embodiments, different validators 124 may be used including but not limited to a containerization validator 124 and manifest validator 124.

Each validator 124 may perform similar functionality, in that the validator 124 may parse, compile, or otherwise examine or compare the output of LLM 110 to an expected output or format of the output. Validator 124 may generate a result 126 indicating whether the output passed the validation test, or whether and/or which errors were identified during the validation process. As will be discussed in greater detail below, if the result 126 indicates that output passed validation, processing will continue to the next step.

However, if the result 126 indicates an error or failure in the generation of the output, then prompt generator 118 may generate a regeneration prompt 120C that includes or indicates the result 126, the regeneration prompt 120C may be submitted back to LLM 110 for processing (e.g., generation of a new output file, which may then be validated again by validator 124). In some embodiments, for an error code detected during the validation of a containerization file 122, the regeneration prompt 120C may include the previously generated containerization file 122 and the result 126 (including the error code) as input and instruction to generate a new containerization file 122 to resolve the indicated error corresponding to the error code.

This process may continue, repeat, or iterate until result 126 indicates that the output file generated by LLM 110 has passed validation. In some embodiments, there may be a threshold number of attempts, after which an error message may be provided to developer 112 or another user indicating the failure to generate the particular output file.

In some embodiments, the validator 124, result 126, and regeneration prompt 120C may serve as a feedback or training loop for LLM 110. In repeating the generation of a particular output file (such as containerization file 122), through the processing of the regeneration prompt 120C, LLM 110 may ‘learn’ better how to generate a particular output file. LLM 110 may then utilize this ‘learning’ when creating future files in response to a containerization prompt 120A, manifest prompt 120B, and/or regeneration prompt 120C. For example, if result 126 indicates an error code such as “error 107” and LLM 110 corrects the error through regenerating an output file. LLM 110 may now be better configured to generate the output file in a manner that avoids ‘error 107’ in the first place, and/or is better equipped to resolve ‘error 107’ when it occurs.

LLM 110 may generate containerization file 122 in response to receiving containerization prompt 120A. Validator 124 may then check or validate containerization file 122, to ensure it was generated correctly (e.g., in accordance with the format, specifications, and configurations expected of a containerization file, as indicated by configuration 134). If result 126 indicates an error or failure. Prompt generator 118 may, without user intervention, generate a rengeneration prompt 120C indicating the result 126 returned by validator 124.

ACS 102 may provide the regeneration prompt 120C to LLM 110 which may then generate a new containerization file 122 to correct the error (e.g. such as syntax errors) or failure indicated in the regeneration prompt 120C. In doing so, LLM 110 may ‘learn’ how to address, correct, and even avoid errors in generating containerization file 122. This process may repeat until a threshold number of retries has been reached, or the result 126 indicates that the containerization file 122 has passed. In some embodiments, after regeneration of a containerization file 122, feedback may be provided when the new containerization file 122 passes validation by validator 124.

Prompt generator 118 may receive the validated containerization file 122 (e.g., which has passed validation by validator 124), and generate a manifest prompt 120B. The manifest prompt 120B may include instructions for LLM 110 to generate a manifest 106 which may be used to deploy the containerization file 122 (corresponding to the source code 104) via the deployment platform 108. In some embodiments, the generated containerization file 122 may be included as part of the input of the manifest prompt 120B.

Manifest 106 may include a file (or files) that describes or defines the configuration and specification for the deployment of source code 104. Manifest 106 may be or include a blueprint that describes the runtime parameters necessary for deployment platform 108 for running the software application of source code 104. In some embodiments, manifest 106 may be formatted in a JSON (JavaScript Object Notation) format.

In some embodiments, manifest 106 may include various information including, but not limited to, a specific version of the deployment platform 108 to use, definitions for one or more artifacts 128, metadata, the number of sessions that may need to be supported, how many instances to make available, the resources that are available, etc. For simplicity, only a single artifact 128 is illustrated, however it is understand that any number of artifacts 128 may be generated, as described herein. In some embodiments, the artifact 128 may include a container image, and manifest 106 may describe the image of artifact 128.

LLM 110 may generate manifest 106, including artifacts 128, based on reading or parsing source code 104 which may include all or most of the details necessary for generating manifest 106. In some embodiments, if additional information is necessary for the generation of manifest 106, LLM 110 may indicate certain input is missing. ACS 102 may then request this information from developer 112 through plugin 116. For example, ACS 102 may generate a prompt to developer 112 for any missing or inaccurate information. And upon receiving the missing information, prompt generator 118 may generate a new manifest prompt 120B for generating the manifest 106, and including the previously missing information received from developer 112.

In some embodiments, LLM 110 may have access to read and parse source code 104 in IDE 114 through plugin 116. In some embodiments, LLM may parse source code 104 to identify an application 130 of the source code 104. Application 130 may include for what purpose or use the source code 104 has been generated. Example applications 130 include, but are not limited to, a web server, a number of jobs to be run, a static website or replica-set, a database store or stateful-set, and monitoring application to be run across multiple modes or Daemon-set, etc.

Based on the application 130, LLM 110 may identify a set of one or more artifacts 128 that are to be created for deploying the source code 104 in accordance with the application 130. Artifact 128 may include an object or software component that is configured and used in the application 130. Example artifacts 128 may include deployment, configmap, secret, service, horizontal pod autoscaler (HPA), roles, and rolebindings. For example, a Kubernetes manifest may be configured in a YAML (yet another markup language) to deploy a custom-built we4b server application (e.g., implemented using one or more computing nodes, Python, Java, etc.). The Kubernetes manifest file may include specification for deployment, service, ingress, secret and configmap. .

In some embodiments, ACS 102 may validate the generation of each artifact 128 (e.g., prior to its inclusion in manifest 106). Similar to the process described above with respect to validator 124 and containerization file 122, validator 124 may validate the generation of an artifact 128. And if the artifact 128 fails validation as indicated by result 126. Prompt generator 118 may generate a regeneration prompt 120C for the failed artifact 128, and the process may repeat until the artifact 128 passes, or the threshold retries has been reached. In some embodiments, ACS 102 may use or have access to a separate artifact validator 124.

Once the artifacts 128 have been generated (and validated), prompt generator 118 may generate a new manifest prompt 120B to instruct LLM 110 to generate manifest 106 from the validated artifacts 128. In some embodiments, the original manifest prompt 120B may already include this instruction to generate the manifest 106 upon completion of or validation of the artifact(s) 128. LLM 110 may then generate the manifest 106.

Similar to the process described above with respect to validator 124 and containerization file 122, a manifest validator 125 may then validate manifest 106, and in the event of a failure result 126, prompt generator 118 may generate a manifest regeneration prompt 120C and a new manifest 106 may be generated by LLM 110 and validated by validator 124 until the result 126 indicates a pass or the threshold retries has been reached. LLM 110, may again, learn from the regeneration of artifacts 128 and/or manifest 106 if necessary based on result 126.

In some embodiments, manifest 106 may be generated with any artifacts 128 without individual validation of the artifacts 128 prior to the generation of the manifest 106, based on whether the artifacts 128 and/or source code 104 meet or exceed various thresholds. For example, if there are less than three artifacts and less than 1000 lines of codes, then LLM 110 may directly generate the manifest 106 without validation of each individual artifact 128 before assembly or inclusion in manifest 106 (e.g., these threshold numbers are provided for exemplary purposes only). Skipping the individual artifact pre-validation may save computing resources and time for smaller jobs that do not exceed the threshold parameters (e.g., for number of lines of source code 104, number of artifacts 128, type of application 130, etc.). However, the artifacts 128 may still be validated as part of the validation of the overall manifest 106, even if not individually validated prior to the generation of the manifest 106.

In some embodiments, LLM 110 may have access to a library 132 which may be used to generate containerization file 122, artifacts 128 and/or manifest 106. Library 132 may include a collection of configurations 134 specifying the requirements, format, syntax, etc. for the various outputs to be generated by LLM 110 (as indicted by the prompts 120).

The configurations 134 may periodically change and be updated. However, LLM 110 may be trained on previous or older versions of the configurations 134. The older configurations 134 may not be operable on newer platforms, such as a new version of deployment platform 108. As such, ACS 102 may periodically update the configurations 134 of library 132 to ensure compliance with the latest version or the appropriate version (e.g., which may be specified in source code 104).

In some embodiments, this updating may be done asynchronously (e.g., when library 132 is not in use). In some embodiments, upon identifying application 130 and artifacts 128, ACS 102 may check and ensure that the configurations 134 for the requisite artifacts 128 are up-to-date, and if not, may update the configurations 134 in library 132 prior to usage by LLM 110. In some embodiments, configurations 134 may be used in the generation of containerization file 122, artifact 128, and/or manifest 106, and may be included with any of prompts 120A-C.

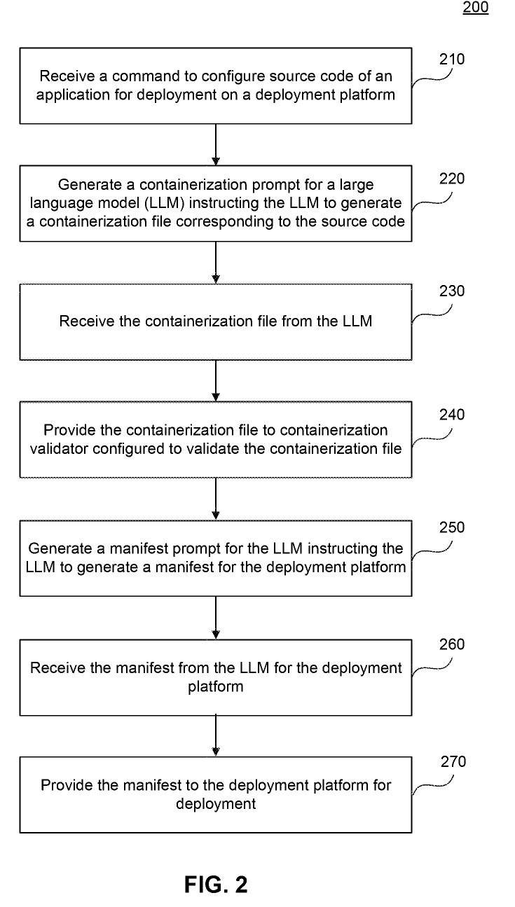

FIG. 2 is a flowchart 200 illustrating example operations for providing an application containerization system (ACS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, a command to configure source code of an application for deployment on a deployment platform is received. For example, developer 112 may request that source code 104 be deployed on deployment platform 108 via plugin 116. Plugin 116 may be installed or integrated into IDE 114 where source code 104 resides, was developed, and/or is organized. Developer may press a button or make a menu selection requesting deployment of source code 104. Source code 104 may include computing code written in any computing language and across any number of files.

In 220, a containerization prompt for a large language model (LLM) instructing the LLM to generate a containerization file corresponding to the source code is generated. For example, the request or command to deploy source code 104 may be received by ACS 102 via plugin 116. In some embodiments, ACS 102 may be integrated into plugin 116. Prompt generator 118 may then generate a containerization prompt 120A instructing LLM 110 to generate a containerization file 122 for source code 104. LLM 110 may directly access source code 104 in IDE 114 through plugin 116, rather than requiring source code 104 to be packaged and transmit to LLM 110. In some embodiments, containerization prompt 120A may indicate the location of or identify the source code 104 (e.g., such as by title, file name(s), etc.).

In 230, the containerization file from the LLM is received. For example, LLM 110 may read source code 104, identify the computing language used in source code 104, and generate containerization file 122 in accordance with containerization prompt 120A (which may be have been provided by ACS 102 to LLM 110). LLM 110 may then return the containerization file 122 to ACS 102.

In 240, the containerization file is provided to containerization validator configured to validate the containerization file. For example, validator 124 may validate the containerization file 122 to ensure it complies with the expected output, format, syntax, terminology, and/or configurations expected of the containerization file 122. In some embodiment, LLM 110 may use configurations 134 to generate containerization file 122, and validator 124 may use the same configurations 134 to validate the containerization file 122 and generate a result 126. The result 126 may indicate a pass or fail / error result. If the result 126 indicates a fail / error, then prompt generator 118 may generate a regeneration prompt 120C, including the result 126, and request LLM 110 to generate a new containerization file 122 to correct the error or address the failure. Once result 126 indicates a pass result, processing may continue to step 250.

In 250, a manifest prompt for the LLM instructing the LLM to generate a manifest for the deployment platform is generated. For example, once containerization file 122 has been generated by LLM 110 (and pass validation by validator 124), prompt generator 118 may generate manifest prompt 120B. In some embodiments, containerization file 122 may be part of the inputs referenced by manifest prompt 120B.

In some embodiments, a first manifest prompt 120B may request the generation of one or more artifacts 128. And once the artifacts 128 have been generated by LLM 110 and validated by validator 124, a second manifest prompt 120B may be generate to request the generation of the manifest 106 from the generated artifacts 128. In other embodiments, both commands may be integrated into a single manifest prompt 120B.

In 260, the manifest is received from the LLM for the deployment platform. For example, ACS 102 may receive the generated manifest 106 including the artifact(s) 128 from LLM 110. In some embodiments, validator 124 may validate each of the artifacts 128 prior to their assembly into manifest 106 of certain parameters and thresholds are exceeded (e.g., regarding lines of source code 104 and/or number of artifacts to be generated). The artifacts 128 may then be assembled into manifest 106 which is returned to ACS 102.

In 270, the manifest is provided to the deployment platform for deployment. For example, ACS 102 may provide the manifest 106 (and in some embodiments, the containerization file 122 as well) to deployment platform 108 (e.g., KUBERNETES) for deployment.

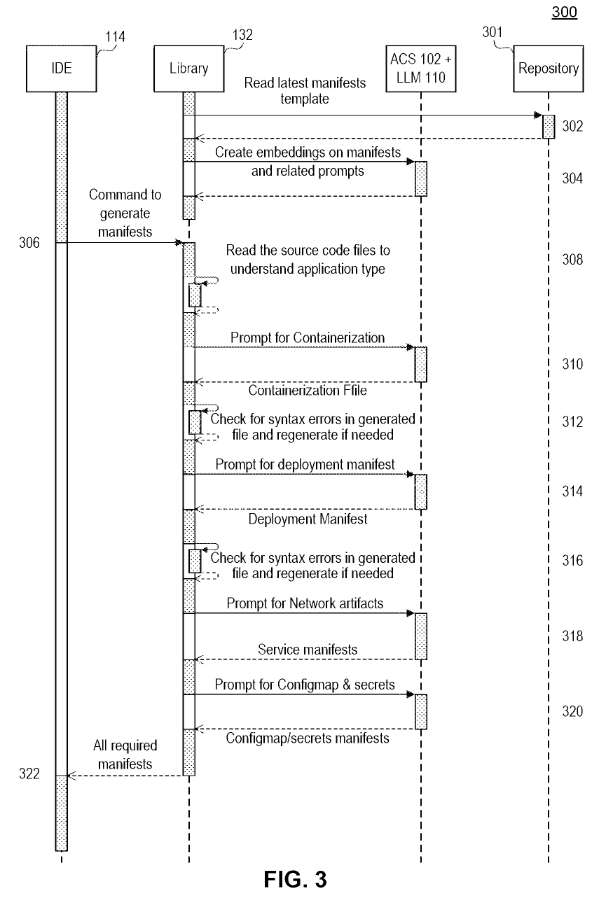

FIG. 3 is a swim lane diagram illustrating example operations for providing an application containerization system (ACS) 102, according to some embodiments.

At 302, library 132 may read the latest manifests and templates (e.g., configurations 134) from a repository 301. Repository 301 may include any network-accessible storage location where library 132 can read and download the latest configurations 134 for the generation of a manifest 106 and/or artifacts 128 by LLM 110.

At 304, embeddings may be created for LLM 110. Creating embeddings may refer to the process of converting the configurations 134 (including those downloaded at step 302) into a model or representation that is understandable by LLM 110. If there was nothing new in 302, then no new embeddings may be created and this step may be skipped.

At 306, a command may be received by ACS 102 from IDE 114 requesting to generate a manifest 106 or deploy source code 104 via a deployment platform 108.

At 308, prompt generator 118 may read source code 104 from IDE 114 via plugin 116. In some embodiments, prompt generator 118 may generate a prompt 120 to instruct LLM 110 to identify application 130 from source code 104. In some embodiments, LLM 110 may have direct access to read source code 104 via plugin 116. In some embodiments, LLM 110 may not have write permission for source code 104 via plugin 116.

At 310, prompt generator 118 may receive the identification of application 130 from LLM 110, and generate a containerization prompt 120A for LLM 110. In some embodiments, the generation of containerization prompt 120A may include retrieving the latest configuration 134 from library 132 and integrating the configuration information for a containerization file into the containerization prompt 120A. LLM 110 may generate and return an containerization file 122 to ACS 102.

At 312, validator 124 may validate the containerization file 122, comparing it against containerization file configurations 134, and generating a result 126. If result 126 indicates an error occurred, prompt generator 118 may generate a regeneration prompt 120C for LLM 110 to create a new version of containerization file 122 correcting the error (which may be included in regeneration prompt 120C). In some embodiments, containerization file 122 may be included as part of the input of the regeneration prompt 120C. If result 126 indicates the containerization file 122 passed the validation, processing may continue to 314. In some embodiments, LLM 110 may be trained to improve functionality through this feedback process, particularly with regard to resolving or avoiding errors identified during the validation processing (e.g., which are then included in the regeneration prompt 120C).

At 314, prompt generator 118 may generate manifest prompt 120B for the generation of manifest 106, including one or more artifacts 128. LLM 110 may generate the manifest 106, including the one or more artifacts 128, responsive to the manifest prompt 120B.

At 316, validator 124 may validate the manifest 106 against configurations 134. In some embodiments, validator 124 may check for formatting, syntax, punctuation, and other errors. If result 126 indicates an error has occurred, then prompt generator 118 may generate a regeneration prompt 120C for the manifest 106, which may be re-created by LLM 110 to correct the indicated error(s).

At 318, prompt generator 118 may generate a prompt 120 for the generation of artifacts 128. LLM 110 may then generate the artifacts 128 and return them in a manifest 106.

At 320, prompt generator 118 may generate a prompt 120 for the generation of a configmap and secrets. LLM 110 may then generate the configmap and secrets and return them in a manifest 106.

As illustrated in FIG. 3, in some embodiments, there may be multiple different manifests 106 generated and/or used during deployment. For example, at 314, LLM 110 may generate a deployment manifest, at 318, LLM 110 may generate a service manifest, and at 320, LLM 110 may generate a configmap and/or secrets manifest. In some embodiments, the order in which the manifests are generated may vary. In some embodiments, each manifest 106 may be individually validated by validator 124 as described above, and regeneration prompts 120C may be generated as needed.

At 322, once the manifest(s) 106 have been generated and validated, the manifest(s) 106 may be returned to IDE 114 for deployment via deployment platform 108. In some embodiments, ACS 102 may directly deploy the manifest(s) 106 via deployment platform 108 without specific user instruction or further user intervention. ACS 102 may then notify the developer 112 of the successful, unsuccessful deployment.

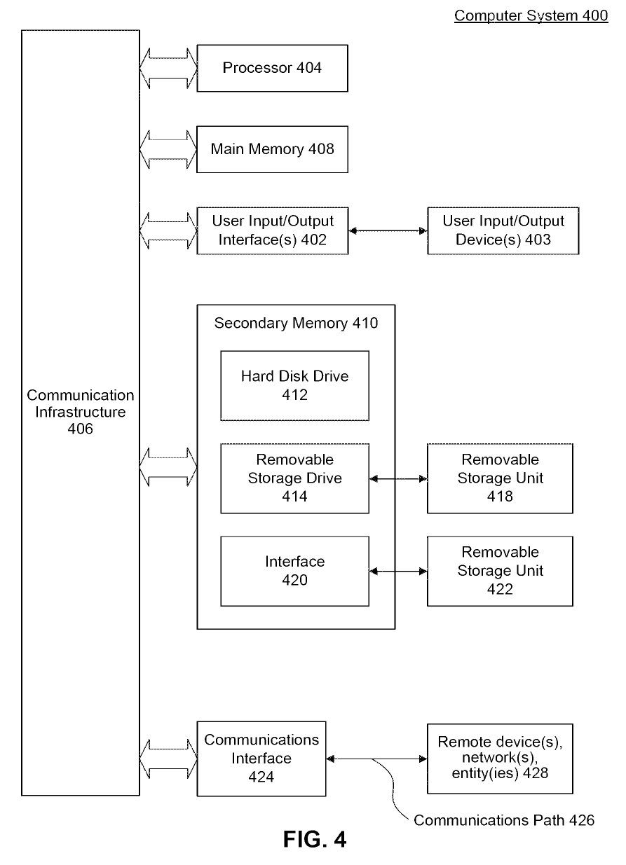

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include user input/output device(s) 403, such as monitors, keyboards, pointing devices, etc., which may communicate with communication infrastructure 406 through user input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/ any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method comprising:
receiving a command to configure source code of an application for deployment on a deployment platform;
generating, by one or more processors, a containerization prompt for a large language model (LLM) instructing the LLM to generate a containerization file corresponding to the source code;
receiving the containerization file from the LLM;
providing the containerization file to a containerization validator configured to validate the containerization file;
generating, by the one or more processors, a manifest prompt for the LLM instructing the LLM to generate a manifest for the deployment platform;
receiving the manifest from the LLM for the deployment platform; and
providing, by the one or more processors, the manifest to the deployment platform for the deployment.

2. The computer-implemented method of claim 1, wherein the command is received via a plugin for an integrated development environment comprising the source code.

3. The computer-implemented method of claim 1, wherein the deployment platform comprises KUBERNETES.

4. The computer-implemented method of claim 1, wherein the generating the manifest comprises:
receiving a first artifact generated by the LLM as part of the manifest;
providing the first artifact to a manifest validator configured to validate the manifest including the first artifact; and
receiving a validation result from the manifest validator regarding the first artifact.

5. The computer-implemented method of claim 4, further comprising:
determining that the validation result indicates that the validation failed;
generating, by the one or more processors, a regeneration prompt indicating the validation result, the regeneration prompt instructing the LLM to correct the first artifact;
receiving a new version of the first artifact as generated by the LLM in response to the regeneration prompt; and
providing, by the one or more processors, the new version of the first artifact to the manifest validator for validating.

6. The computer-implemented method of claim 5, wherein the validation result comprises an error code, and wherein the regeneration prompt includes the error code.

7. The computer-implemented method of claim 1, wherein the providing the containerization file to the containerization validator comprises:
determining that a containerization validation result comprises an error code;
generating, by the one or more processors, a regeneration prompt including the error code indicating the containerization validation result, the regeneration prompt instructing the LLM to correct the containerization file;
receiving a new version of the containerization file as generated by the LLM in response to the regeneration prompt; and
providing the new version of the containerization file to the containerization validator for validating.

8. The computer-implemented method of claim 1, further comprising:
updating one or more configurations associated with the manifest, wherein the updating is performed after receiving the command and prior to receiving the manifest from the LLM, wherein the LLM is configured to use the one or more configurations in generating the manifest.

9. A system comprising:
a memory; and
at least one processor coupled to the memory and configured to perform operations comprising:
receiving a command to configure source code of an application for deployment on a deployment platform;
generating a containerization prompt for a large language model (LLM) instructing the LLM to generate a containerization file corresponding to the source code;
receiving the containerization file from the LLM;
providing the containerization file to a containerization validator configured to validate the containerization file;
generating a manifest prompt for the LLM instructing the LLM to generate a manifest for the deployment platform;
receiving the manifest from the LLM for the deployment platform; and
providing the manifest to the deployment platform for the deployment.

10. The system of claim 9, wherein the command is received via a plugin for an integrated development environment comprising the source code.

11. The system of claim 9, wherein the deployment platform comprises KUBERNETES.

12. The system of claim 9, wherein the generating the manifest comprises:
receiving a first artifact generated by the LLM as part of the manifest;
providing the first artifact to a manifest validator configured to validate the manifest including the first artifact; and
receiving a validation result from the manifest validator regarding the first artifact.

13. The system of claim 12, the operations further comprising:
determining that the validation result indicates that the validation failed;
generating a regeneration prompt indicating the validation result, the regeneration prompt instructing the LLM to correct the first artifact;
receiving a new version of the first artifact as generated by the LLM in response to the regeneration prompt; and
providing the new version of the first artifact to the manifest validator for validating.

14. The system of claim 13, wherein the validation result comprises an error code, and wherein the regeneration prompt includes the error code.

15. The system of claim 9, wherein the providing the containerization file to the containerization validator comprises:
determining that a containerization validation result comprises an error code;
generating a regeneration prompt including the error code indicating the containerization validation result, the regeneration prompt instructing the LLM to correct the containerization file;
receiving a new version of the containerization file as generated by the LLM in response to the regeneration prompt; and
providing the new version of the containerization file to the containerization validator for validating.

16. The system of claim 9, the operations further comprising:
updating one or more configurations associated with the manifest, wherein the updating is performed after receiving the command and prior to receiving the manifest from the LLM, wherein the LLM is configured to use the one or more configurations in generating the manifest.

17. A non-transitory computer-readable medium having instructions stored thereon that, when executed by at least one computing device, cause the at least one computing device to perform operations comprising:
receiving a command to configure source code of an application for deployment on a deployment platform;
generating a containerization prompt for a large language model (LLM) instructing the LLM to generate a containerization file corresponding to the source code;
receiving the containerization file from the LLM;
providing the containerization file to a containerization validator configured to validate the containerization file;
generating a manifest prompt for the LLM instructing the LLM to generate a manifest for the deployment platform;
receiving the manifest from the LLM for the deployment platform; and
providing the manifest to the deployment platform for the deployment.

18. The non-transitory computer-readable medium of claim 17, wherein the command is received via a plugin for an integrated development environment comprising the source code.

19. The non-transitory computer-readable medium of claim 17, wherein the deployment platform comprises KUBERNETES.

20. The non-transitory computer-readable medium of claim 17, wherein the generating the manifest comprises:
receiving a first artifact generated by the LLM as part of the manifest;
providing the first artifact to a manifest validator configured to validate the manifest including the first artifact; and
receiving a validation result from the manifest validator regarding the first artifact.
